(19) United States
(12) Patent Application Publication
(10) Pub. No.: US 2025/0314392 A1
(43) Pub. Date: Oct. 9, 2025

(54) AIR CONDITIONING SYSTEM AND OUTDOOR UNIT

(71) Applicant: Mitsubishi Electric Corporation, Tokyo (JP)

(72) Inventor: Yoshiaki KOIZUMI, Tokyo (JP)

(21) Appl. No.: 18/871,548

(22) PCT Filed: Jun. 30, 2022
(86) PCT No.: PCT/JP2022/026203

§ 371 Date: Dec. 4, 2024

(51) Int. Cl. F24F 11/63

(52) U.S. Cl. CPC F24F 11/63

(57) ABSTRACT

An air conditioning system includes a plurality of devices that at least include one or more outdoor units, one or more indoor units, one or more sensor devices, and one or more assistance devices. At startup of the system, an IP address is assigned to each of the plurality of devices by at least one of the plurality of devices.

### CROSS-REFERENCE TO RELATED APPLICATION

This application is a U.S. national stage application of PCT/JP2022/026203 filed on Jun. 30, 2022, the contents of which are incorporated herein by reference.

### TECHNICAL FIELD

The present disclosure relates to an air conditioning system and an outdoor unit.

### BACKGROUND

Patent Literature 1 discloses an air conditioning system that enables Internet Protocol (IP) communication between air conditioners. This air conditioning system includes multiple air conditioners connected to multiple networks and having unique IDs, a router that separates the multiple networks and assigns an IP address to each of the air conditioners, and a management device that receives, from each of the air conditioners, device information associating the assigned IP address and the ID, generates information table including the received device information in a batch, and transmits the information table to each of the air conditioners. Each of the air conditioners can store the information table, and communication between air conditioners connected to different networks is performed through transmission by each of the air conditioners of information, using the information table, via the router to the air conditioner connected to the network of a transmission target side.

### Patent Literature

Patent Literature 1: Japanese Patent No. 4380738

In air conditioning systems for air conditioning of an office building, a shop, or the like, system configuration that includes a device other than an air conditioner (outdoor unit and indoor unit), for example, a sensor such as a temperature sensor, a humidity sensor, or a motion detector, or a device that assists air conditioning performed by the air conditioner, such as a dehumidifier, a humidifier and that is hereinafter referred to as the “assistance device”, is not uncommon.

However, with the technique disclosed in Patent Literature 1 that simply enables IP communication between the air conditioners, adding the aforementioned sensor devices, assistance devices, and the like to the system configuration requires separately using a protocol conversion device that enables communication with these devices. Furthermore, the technique disclosed in Patent Literature 1 requires separately arranging a dedicated device for assigning an IP address to each of the air conditioners. For this reason, proposals are desired of a new technique that enables IP communication in the entire system while eliminating the need for a dedicated device.

### SUMMARY

The present disclosure is made in view of the aforementioned circumstances, and an objective of the present disclosure is to provide an air conditioning system and an outdoor unit that enable IP communication in the entire system while eliminating the need for a dedicated device for assigning an IP address.

To achieve the above objective, an air conditioning system according to the present disclosure includes a plurality of devices that at least include one or more outdoor units, one or more indoor units, one or more sensor devices, and one or more air-conditioning assistance devices, and at startup of the system, an IP address is assigned to each of the plurality of devices by at least one of the plurality of devices.

The present disclosure enables IP communication in the entire system while eliminating the need for a dedicated device for assigning an IP address.

### BRIEF DESCRIPTION OF DRAWINGS

FIG. 1 illustrates overall configuration of an air conditioning system according to Embodiment 1;

FIG. 2 is a block diagram illustrating hardware configuration of a centralized controller according to Embodiment 1;

FIG. 3 is a block diagram illustrating hardware configuration of an outdoor unit according to Embodiment 1;

FIG. 4 is a block diagram illustrating hardware configuration of an indoor unit according to Embodiment 1;

FIG. 5 illustrates functional configuration of a centralized controller according to Embodiment 1;

FIG. 6 illustrates an example of IP addresses assigned by the centralized controller according to Embodiment 1;

FIG. 7 illustrates functional configuration of the outdoor unit according to Embodiment 1;

FIG. 8 illustrates an example of IP addresses assigned by the outdoor unit according to Embodiment 1;

FIG. 9 is a flowchart illustrating a sequence of IP address assignment processing executed by the centralized controller according to Embodiment 1;

FIG. 10 is a flowchart illustrating a sequence of IP address assignment processing executed by the outdoor unit according to Embodiment 1;

FIG. 11 illustrates overall configuration of an air conditioning system according to a modified example of Embodiment 1;

FIG. 12 illustrates overall configuration of an air conditioning system according to another modified example of Embodiment 1;

FIG. 13 illustrates an example of a domain name management table according to still another modified example of Embodiment 1;

FIG. 14 illustrates overall configuration of an air conditioning system according to Embodiment 2;

FIG. 15 illustrates functional configuration of a centralized controller according to Embodiment 2;

FIG. 16 illustrates functional configuration of an outdoor unit according to Embodiment 2; and

FIG. 17 illustrates overall configuration of an air conditioning system according to a modified example of Embodiment 2.

### DETAILED DESCRIPTION

Hereinafter, embodiments of the present disclosure are described in detail with reference to the drawings.

### Embodiment 1

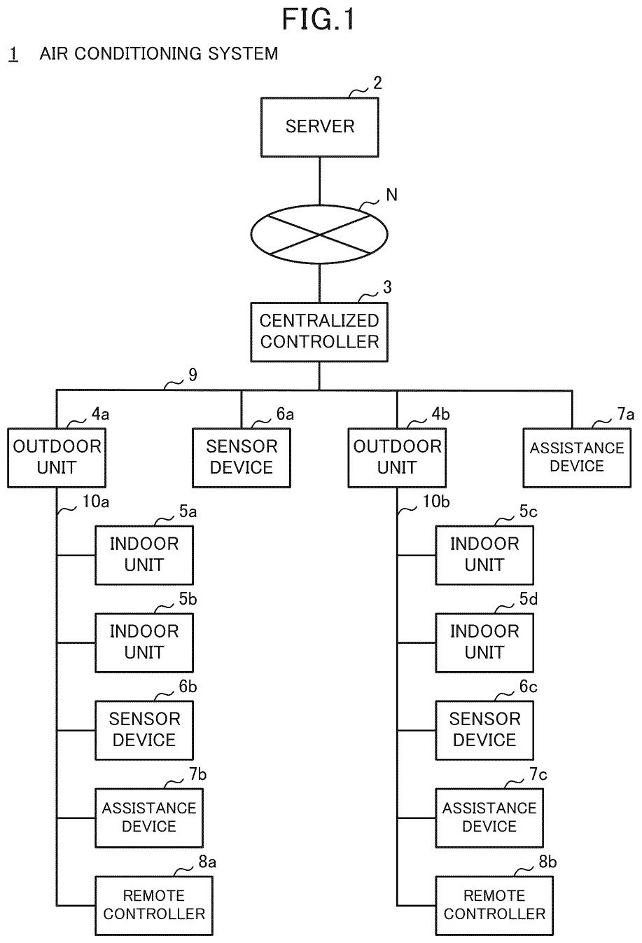

FIG. 1 illustrates overall configuration of an air conditioning system 1 according to Embodiment 1 of the present disclosure. The air conditioning system 1 is an example of an air conditioning system according to the present disclosure. The air conditioning system 1 is, for example, a system that performs air conditioning of a building such as an office building or a shop, and includes a server 2, a centralized controller 3, outdoor units 4a and 4b, indoor units 5a-5d, sensor devices 6a-6c, assistance devices 7a-7c, and remote controllers 8a and 8b.

### Server 2

The server 2 is a server computer that is installed and operated by a manufacturer, a vender, or the like of air conditioners that are the outdoor units 4a and 4b and the indoor units 5a-5d and is connected to a network N. The server 2 may be a server that provides a public cloud. The server 2 sends a program for updating to an air conditioner with a program to be updated.

Additionally, the server 2 collects data of each of devices that are the outdoor units 4a and 4b, the indoor units 5a-5d, the sensor devices 6a-6c and the assistance devices 7a-7c and provides a service for controlling air conditioning of the building based on the collected data or a service for presenting information based on the collected data to a person involved in the air conditioning system 1, such as an owner of the building, a system administrator, or a maintenance operator.

### Centralized Controller 3

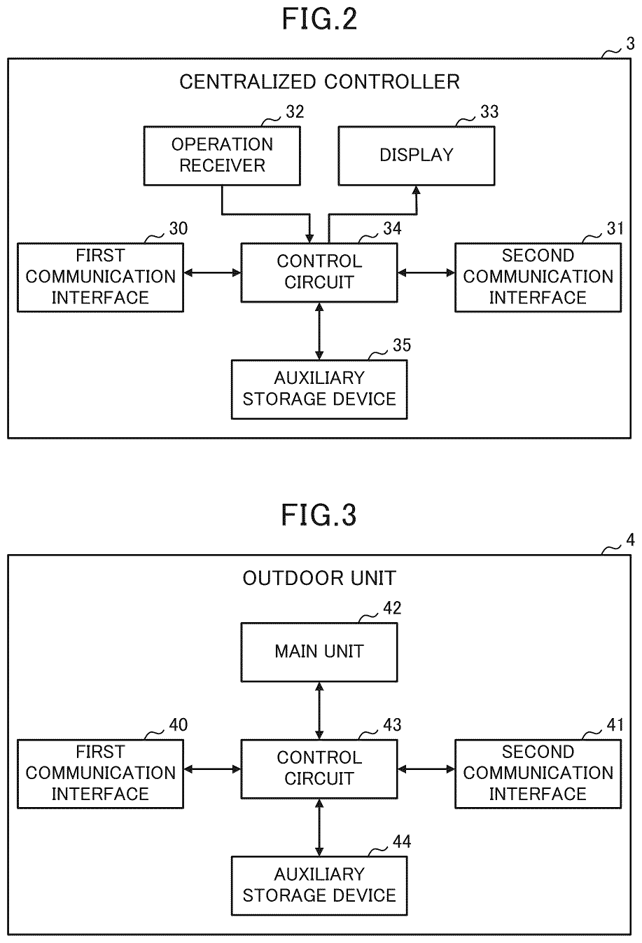

The centralized controller 3 is an example of a centralized controller according to the present disclosure. The centralized controller 3 is a device for performing centralized control of the devices in the air conditioning system 1 that are the outdoor units 4a and 4b, the indoor units 5a-5d, the sensor devices 6a-6c, and the assistance devices 7a-7c, such as cooperation control of these devices, and is installed at a place allowing entry only by the person involved, such as a control room in the building. As illustrated in FIG. 2, the centralized controller 3 includes, as hardware components, a first communication interface 30, a second communication interface 31, an operation receiver 32, a display 33, a control circuit 34, and an auxiliary storage device 35.

The first communication interface 30 is an interface connectable to the network N for communication with the server 2. The second communication interface 31 is an interface for Internet Protocol (IP) communication in a first communication method with each of the devices that are the outdoor units 4a and 4b, the sensor device 6a and the assistance device 7a and that are connected to a transmission line 9 as an integrated transmission line. The first communication method is, for example, Ethernet®.

The operation receiver 32 includes one or more input devices, for example, a keyboard, a mouse, a keypad, a push button, a touch panel, a touch pad, and the like, receives an input operation from a user and outputs a signal relating to the received input operation to the control circuit 34. The display 33 includes a display device, such as a liquid crystal display or an organic electro luminescence (EL) display. The display 33 displays, under the control of the control circuit 34, a screen for monitoring an operation of each of the devices included in the air conditioning system 1, a screen for controlling each of the devices, and the like.

The control circuit 34 includes a central processing unit (CPU), a read only memory (ROM), a random access memory (RAM), and the like, and performs overall control of the centralized controller 3. Functions of the centralized controller 3 that are achieved by the control circuit 34 are described below in detail.

The auxiliary storage device 35 includes a readable and writable non-volatile semiconductor memory, a hard disk drive (HDD), or the like. The readable and writable non-volatile semiconductor memory is, for example, an electrically erasable programmable read-only memory (EEPROM), a flash memory, or the like. The auxiliary storage device 35 stores an integrated control program that is a program for achieving functions equivalent to the Dynamic Host Configuration Protocol (DHCP) server function and for performing centralized control of the devices included in the air conditioning system 1, and data to be used in execution of the integrated control program.

The centralized controller 3 may acquire the integrated control program from the server 2 or other server by communication via the network N and store the integrated control program in the auxiliary storage device 35. Also, the integrated control program may be stored and distributed in a computer-readable recording medium, such as a compact disc read only memory (CD-ROM), a digital versatile disc (DVD), a magneto-optical disc, a universal serial bus (USB) memory, an HDD, a solid state drive (SSD), or a memory card. The centralized controller 3 may, upon direct or indirect attachment thereto of such recording medium, read out the integrated control program from this recording medium and store the integrated control program in the auxiliary storage device 35.

### Air Conditioner (Outdoor Units 4a and 4b, Indoor Units 5a-5d)

The outdoor unit 4a is connected to the transmission line 9 and a transmission line 10a that is an internal-external transmission line. The outdoor unit 4a and the indoor units 5a and 5b are connected via the transmission line 10a and are also connected via non-illustrated first refrigerant piping for circulation of refrigerant. That is, the outdoor unit 4a and the indoor units 5a and 5b constitute a single refrigerant system.

The outdoor unit 4b is connected to the transmission line 9 and a transmission line 10b that is an internal-external transmission line. The outdoor unit 4b and the indoor units 5c and 5d are connected via the transmission line 10b and are also connected via non-illustrated second refrigerant piping for circulation of refrigerant that is different from the aforementioned first refrigerant piping. That is, the outdoor unit 4b and the indoor units 5c and 5d constitute a single refrigerant system.

Hereinafter, in explanation of matters that are common between the outdoor units 4a and 4b, these outdoor units are referred to as the outdoor units 4 without individual designation, in explanation of matters that are common among the indoor units 5a-5d, these indoor units are referred to as the indoor units 5 without individual designation, and in explanation of matters that are common between the transmission lines 10a and 10b, these communication lines are referred to as the transmission lines 10 without individual designation.

### Sensor Devices 6a-6c

The sensor devices 6a-6c are each an example of a sensor device according to the present disclosure. The sensor devices 6a-6c are each, for example, a sensor that measures an air condition of an air-conditioning target space such as air temperature, humidity, and CO₂ concentration, a motion detector that detects presence or absence of a human in the air-conditioning target space, or the like. In the present embodiment, the sensor device 6a is connected to the transmission line 9, the sensor device 6b is connected to the transmission line 10a, and the sensor device 6c is connected to the transmission line 10b. Hereinafter, in explanation of matters that are common among the sensor devices 6a-6c, these sensor devices are referred to as the sensor devices 6 without individual designation.

### Assistance Devices 7a-7c

The assistance devices 7a-7c are each an example of an air-conditioning assistance device according to the present disclosure. The assistance devices 7a-7c are each a device that plays a role of assisting air conditioning by the air conditioners that are the outdoor units 4 and the indoor units 5, such as a dehumidifier, humidifier, ventilator, or air cleaners. In the present embodiment, the assistance device 7a is connected to the transmission line 9, the assistance device 7b is connected to the transmission line 10a, and the assistance device 7c is connected to the transmission line 10b. Hereinafter, in explanation of matters that are common among the assistance devices 7a-7c, these assistance devices are referred to as the assistance devices 7 without individual designation.

### Remote Controllers 8a and 8b

The remote controllers 8a and 8b are each a user interface for receiving from a user an operation relating to air conditioning. In the present embodiment, the remote controller 8a is connected to the transmission line 10a, and the remote controller 8b is connected to the transmission line 10b. Hereinafter, in explanation of matters that are common between the remote controllers 8a and 8b, these remote controllers are referred to as the remote controllers 8 without individual designation.

### Outdoor Unit 4

The outdoor unit 4 is an example of an outdoor unit according to the present disclosure. As illustrated in FIG. 3, the outdoor unit 4 includes, as hardware components, a first communication interface 40, a second communication interface 41, a main unit 42, a control circuit 43, and an auxiliary storage device 44. The first communication interface 40 is an interface for IP communication via the transmission line 9 in the first communication method with the centralized controller 3, the other outdoor unit 4, the sensor device 6a, and the assistance device 7a. The second communication interface 41 is an interface for IP communication via the transmission line 10 in the first communication method with each of the indoor units 5, the sensor device 6, the assistance device 7, and the remote controller 8 that are connected to the local outdoor unit.

The main unit 42 is a component for achievement of fundamental functions of a general outdoor unit, and includes, for example, actuators such as a compressor, an outdoor fan, an electronic expansion valve, and an outdoor electromagnetic valve, and sensors such as a piping temperature sensor that measures a temperature of refrigerant piping and an outdoor air temperature sensor that measures an outdoor air temperature. The control circuit 43 is a microcontroller that performs overall control of the outdoor unit 4. Functions of the outdoor unit 4 that are achieved by the control circuit 43 are described below in detail.

The auxiliary storage device 44 includes a readable-writable non-volatile semiconductor memory, such as EEPROM or flash memory. The auxiliary storage device 44 stores an outdoor unit program that is a program for achieving functions equivalent to the DHCP server function and for performing air conditioning control, and data to be used in execution of the outdoor unit program.

The outdoor unit 4 may acquire the outdoor unit program from the server 2 via the centralized controller 3 and store the outdoor unit program in the auxiliary storage device 44. The outdoor unit program may be distributed by storage in a computer-readable recording medium, such as a CD-ROM, a DVD, a magneto-optical disc, a USB memory, an HDD, an SSD, or a memory card. The outdoor unit 4 may, upon direct or indirect attachment thereto of such recording medium, read out the outdoor unit program from this recording medium and store the outdoor unit program in the auxiliary storage device 44.

### Indoor Unit 5

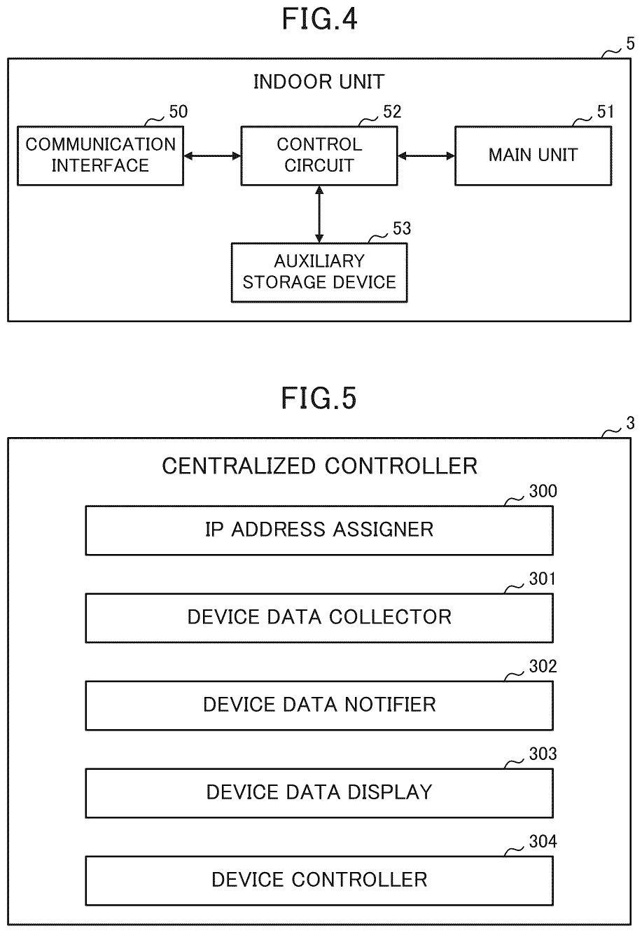

The indoor unit 5 is an example of an indoor unit according to the present disclosure. As illustrated in FIG. 4, the indoor unit 5 includes, as hardware components, a communication interface 50, a main unit 51, a control circuit 52, and an auxiliary storage device 53. The communication interface 50 is an interface for IP communication via the transmission line 10 in the first communication method with the outdoor unit 4, the other indoor unit 5, the sensor device 6, the assistance device 7, and the remote controller 8.

The main unit 51 is a component for achievement of fundamental functions of a general indoor unit, and includes, for example, actuators such as an indoor fan and an indoor electromagnetic valve, and sensors such as a piping temperature sensor that measures a temperature of refrigerant piping and an indoor temperature sensor that measures an indoor temperature.

The auxiliary storage device 53 includes a readable-writable non-volatile semiconductor memory, such as EEPROM or flash memory. The auxiliary storage device 53 stores an indoor unit program that is a program for performing air conditioning control, and data to be used in execution of the indoor unit program.

The indoor unit 5 may acquire the indoor unit program from the server 2 via the centralized controller 3 and store the indoor unit program in the auxiliary storage device 53. The indoor unit program may be distributed by storage in a computer-readable recording medium, such as a CD-ROM, a DVD, a magneto-optical disc, a USB memory, an HDD, an SSD, or a memory card. The indoor unit 5 may, upon direct or indirect attachment thereto of such recording medium, read out the indoor unit program from this recording medium and store the indoor unit program in the auxiliary storage device 53.

### Functional Configuration of Centralized Controller 3

FIG. 5 illustrates functional configuration of the centralized controller 3. As illustrated in FIG. 5, the centralized controller 3 includes an IP address assigner 300, a device data collector 301, a device data notifier 302, a device data display 303, and a device controller 304. These functional elements are achieved by execution, by the CPU of the control circuit 34 included in the centralized controller 3, of the aforementioned integrated control program stored in the auxiliary storage device 35.

The IP address assigner 300 is a functional element equivalent to the DHCP server function. At startup of the air conditioning system 1, the IP address assigner 300 automatically determines an IP address to be assigned to the local device, that is, the centralized controller 3, based on a range of IP addresses predefined by the system administrator, and assigns an IP address to each of the devices connected to the transmission line 9, that is, the outdoor units 4a and 4b, and sensor device 6a, and the assistance device 7a. In the present embodiment, the IP address assigner 300 assigns an IP address based on Internet Protocol version 4 (IPv4) to each of the aforementioned devices.

In detail, upon startup of the air conditioning system 1, each of the devices connected to the transmission line 9 broadcasts, via the transmission line 9, a notification for requesting an IP address that is hereinafter referred to as the “address request notification”. The address request notification stores a Media Access Control (MAC) address of the device. Upon receiving such an address request notification, the IP address assigner 300 determines, based on the predefined range of IP addresses as described above, an IP address to be assigned to the device as a transmission source of the address request notification. The IP address assigner 300 then sends, to the device, a response notification storing the assigned IP address that is hereinafter referred to as the “address response notification”. The device that has received the address response notification from the centralized controller 3 sets, as an IP address of this device, the IP address stored in the address response notification and assigned to this device.

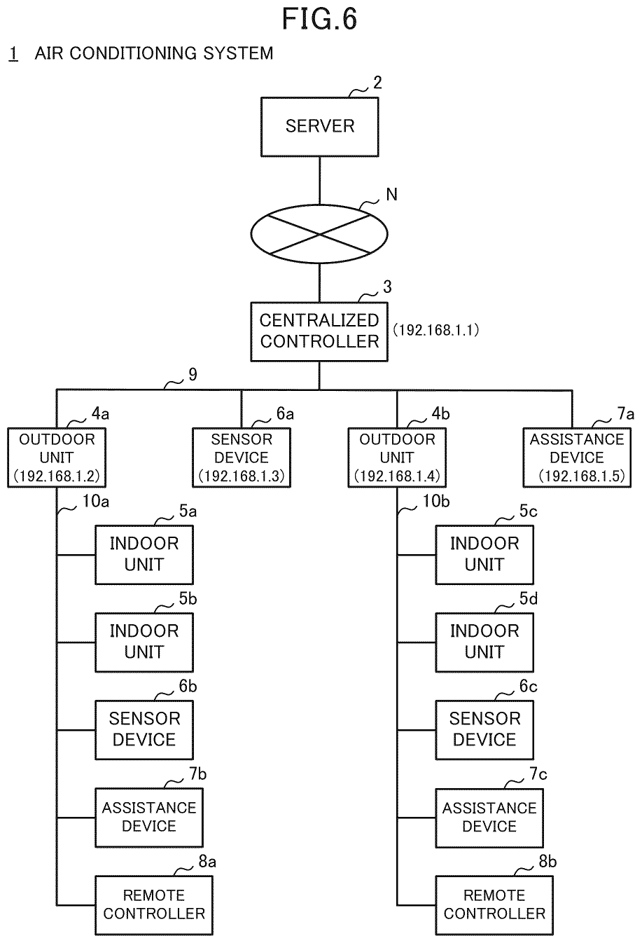

FIG. 6 illustrates an example of IP addresses assigned by the IP address assigner 300 to the centralized controller 3 and each of the devices. FIG. 6 illustrates an example case in which “192.168.1.1” is assigned to the centralized controller 3, that is, to itself, “192.168.1.2” is assigned to the outdoor unit 4a, “192.168.1.3” is assigned to the sensor device 6a, “192.168.1.4” is assigned to the outdoor unit 4b, and “192.168.1.5” is assigned to the assistance device 7a.

The device data collector 301 periodically collects device data from each of the devices, that is, each of the outdoor units 4, each of the indoor units 5, each of the sensor devices 6, and each of the assistance devices 7. The device data contains information indicating a type of the device, information indicating an operation state, a measurement result of a sensor, and the like. The information indicating the operation state is information that is stored only in the case in which the device is the outdoor unit 4, the indoor unit 5 or the assistance device 7, and is information containing an operation mode, a temperature setting, an air flow amount, and the like. Additionally, in the case in which the device is the outdoor unit 4, the indoor unit 5 or the assistance device 7, the measurement result of a sensor indicates a result of measurement by a sensor built in the device.

The device data notifier 302 periodically transmits the collected device data to the server 2. Additionally, upon receiving from the server 2 a request for the device data with designation of a device, the device data notifier 302 transmits to the server 2 the device data of the designated device.

The device data display 303 displays the collected device data on the display 33 in a predetermined manner. For example, the device data display 303 displays, on the display 33, a monitoring screen in which icons each indicating a corresponding device are arranged on a floor plan of the building with content of the device data of each device is displayed on the corresponding icon.

The device controller 304 controls operations of the outdoor units 4, the indoor units 5, and the assistance devices 7 in accordance with an operating condition preset by the owner of the building, the system administrator, or the like, an operating schedule preregistered by the owner of the building, the system administrator, or the like, an instruction from the server 2, and the like.

### Functional Configuration of Outdoor Unit 4

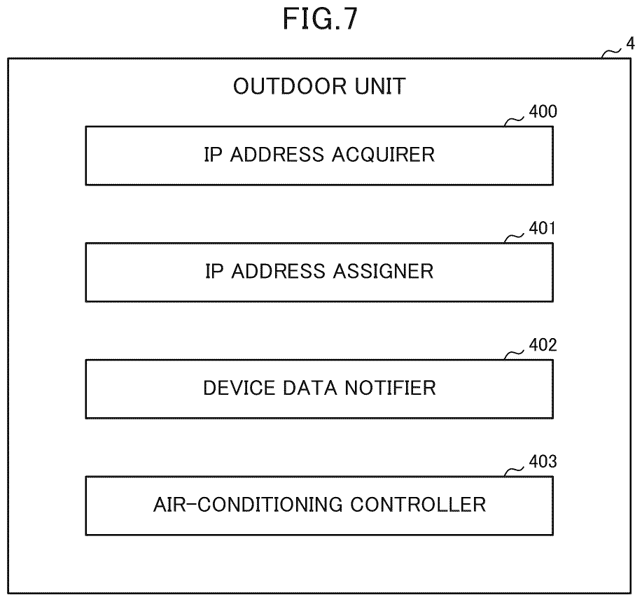

FIG. 7 illustrates functional configuration of the outdoor unit 4. As illustrated in FIG. 7, the outdoor unit 4 includes an IP address acquirer 400, an IP address assigner 401, a device data notifier 402, and an air-conditioning controller 403. These functional elements are achieved by execution, by the CPU of the control circuit 43 included in the outdoor unit 4, of the aforementioned outdoor unit program stored in the auxiliary storage device 44.

The IP address acquirer 400 is an example of IP address acquiring means according to the present disclosure. The IP address acquirer 400 acquires, from the centralized controller 3, the IP address assigned to the outdoor unit 4. In detail, upon startup of the air conditioning system 1, the IP address acquirer 400 broadcasts the aforementioned address request notification via the first communication interface 40, that is, via the transmission line 9. The IP address acquirer 400 receives the address response notification sent from the centralized controller 3 in response to the address request notification, and extracts and acquires the IP address assigned to the outdoor unit 4 that is stored in the address response notification. The IP address acquirer 400 sets the acquired IP address as the IP address of the outdoor unit 4.

The IP address assigner 401 is an example of IP address assigning means according to the present disclosure. The IP address assigner 401 is a functional element equivalent to the DHCP server function. At startup of the air conditioning system 1, the IP address assigner 401 automatically assigns an IP address to each of the devices connected to the outdoor unit 4 via the transmission line 10, that is, the indoor units 5, the sensor device 6, the assistance device 7, and the remote controller 8, based on the IP address of the outdoor unit 4 acquired by the IP address acquirer 400 and the range of IP addresses predefined by the system administrator. In the present embodiment, the IP address assigner 401 assigns an IP address based on IPv4 to each of the aforementioned devices.

In detail, upon startup of the air conditioning system 1, each of the devices connected to the transmission line 10 broadcasts the address request notification via the transmission line 10. The address request notification stores an MAC address of the device. Upon receiving the address request notification, the IP address assigner 401 assigns an IP address to the device that is the transmission source of the address request notification, and sends the address response notification storing the assigned IP address to the device via the second communication interface 41, that is, via the transmission line 10. The device that has received the address response notification from the outdoor unit 4 sets, as an IP address of this device, the IP address stored in the address response notification and assigned to this device.

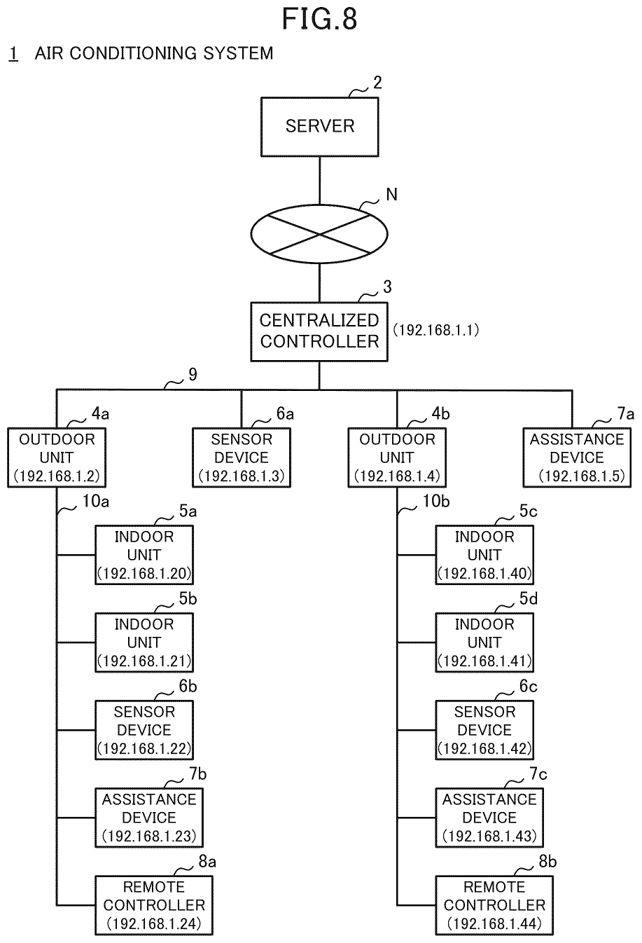

FIG. 8 illustrates an example of IP addresses assigned by the IP address assigner 401 to each of the devices. FIG. 8 illustrates an example case in which “192.168.1.20” is assigned to the indoor unit 5a, “192.168.1.21” is assigned to the indoor unit 5b, “192.168.1.22” is assigned to the sensor device 6b, “192.168.1.23” is assigned to the assistance device 7b, and “192.168.1.24” is assigned to the remote controller 8a, by the outdoor unit 4a, and “192.168.1.40” is assigned to the indoor unit 5c, “192.168.1.41” is assigned to the indoor unit 5d, “192.168.1.42” is assigned to the sensor device 6c, “192.168.1.43” is assigned to the assistance device 7c, and “192.168.1.44” is assigned to the remote controller 8b, by the outdoor unit 4b.

In response to a request from the centralized controller 3, the device data notifier 402 generates the device data that stores information indicating a type of the local device, that is, indicating that being an outdoor unit, information indicating an operation state of the outdoor unit 4, a measurement result of a sensor included in the outdoor unit 4, and the like, and transmits the generated device data to the centralized controller 3 via the first communication interface 40.

The air-conditioning controller 403 controls an operation of the outdoor unit 4 relating to air conditioning. In detail, the air-conditioning controller 403 controls operations of actuators included in the outdoor unit 4, such as a compressor, an outdoor fan, an electronic expansion valve, and an outdoor electromagnetic valve, in accordance with a user operation received by the remote controller 8 connected to the outdoor unit 4 via the transmission line 10 or an instruction from the server 2 or the centralized controller 3.

### IP Address Assignment Processing by Centralized Controller 3

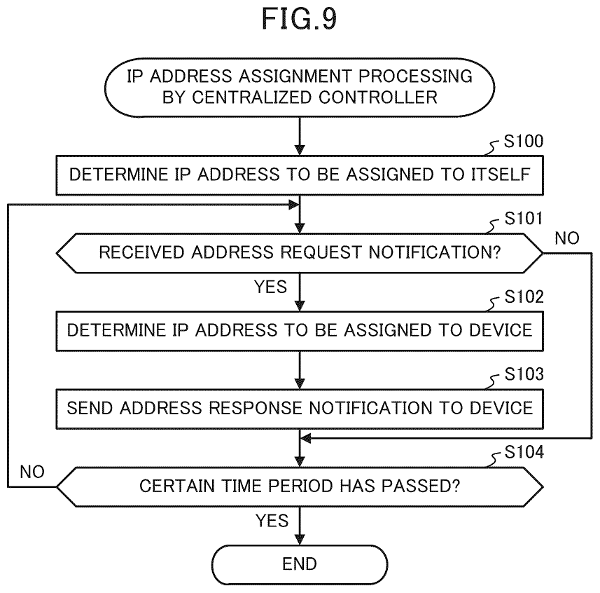

FIG. 9 is a flowchart illustrating a sequence of IP address assignment processing executed by the centralized controller 3 at the startup of the air conditioning system 1.

### Step S100

The centralized controller 3 determines, based on the range of IP addresses predefined by the system administrator, an IP address to be assigned to itself. Thereafter, the processing by the centralized controller 3 proceeds to step S101.

### Step S101

The centralized controller 3 determines whether the address request notification is received from any of the devices connected to the transmission line 9. When the address request notification is received (YES in step S101), the processing by the centralized controller 3 proceeds to step S102. Conversely, when the address request notification is not received (NO in step S101), the processing by the centralized controller 3 proceeds to step S104.

### Step S102

The centralized controller 3 determines, based on the range of IP addresses predefined by the system administrator, an IP address to be assigned to the device that is the transmission source of the address request notification. Thereafter, the processing by the centralized controller 3 proceeds to step S103.

### Step S103

The centralized controller 3 sends, via the transmission line 9 to the device, the address response notification storing the IP address assigned to the device. Thereafter, the processing by the centralized controller 3 proceeds to step S104.

### Step S104

The centralized controller 3 determines whether a certain time period has passed since the IP address assignment processing is started. When the certain time period has passed (YES in step S104), the centralized controller 3 ends the IP address assignment processing. Conversely, when the certain time period has not passed (NO in step S104), the processing by the centralized controller 3 returns to step S101.

### IP Address Assignment Processing by Outdoor Unit 4

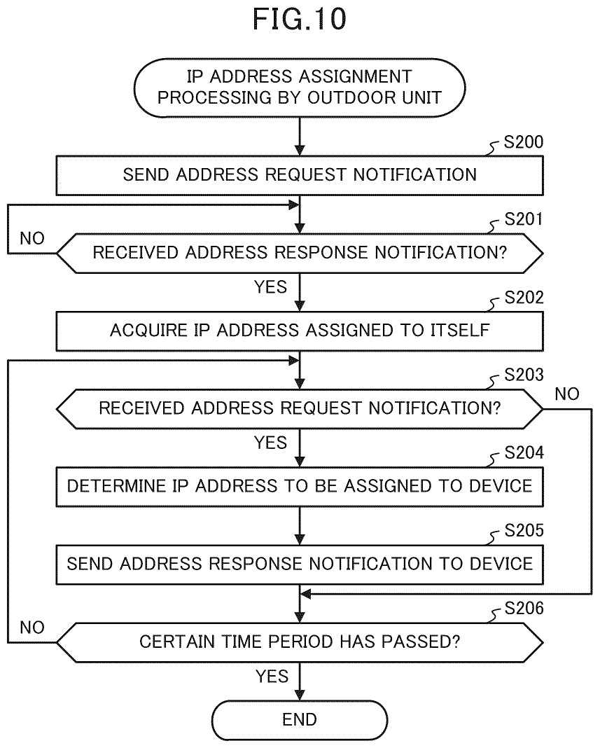

FIG. 10 is a flowchart illustrating a sequence of IP address assignment processing executed by the outdoor unit 4 at the startup of the air conditioning system 1.

### Step S200

The outdoor unit 4 broadcasts the address request notification via the transmission line 9. Thereafter, the processing by the outdoor unit 4 proceeds to step S201.

### Step S201

The outdoor unit 4 determines whether the address response notification is received from the centralized controller 3. When the address response notification is received (YES in step S201), the processing by the outdoor unit 4 proceeds to step S202. Conversely, when the address response notification is not received (NO in step S201), the outdoor unit 4 continuously executes the processing in step S201.

### Step S202

The outdoor unit 4 extracts and acquires the IP address assigned to itself that is stored in the received address response notification. The outdoor unit 4 sets the acquired IP address as the IP address of its own. Thereafter, the processing by the outdoor unit 4 proceeds to step S203.

### Step S203

The outdoor unit 4 determines whether the address request notification is received from any of the devices connected thereto via the transmission line 10. When the address request notification is received (YES in step S203), the processing by the outdoor unit 4 proceeds to step S204. Conversely, when the address request notification is not received (NO in step S203), the processing by the outdoor unit 4 proceeds to step S206.

### Step S204

The outdoor unit 4 determines, based on the IP address of its own and the range of IP addresses predefined by the system administrator, an IP address to be assigned to the device that is the transmission source of the address request notification. Thereafter, the processing by the outdoor unit 4 proceeds to step S205.

### Step S205

The outdoor unit 4 sends, via the transmission line 10 to the device, the address response notification storing the IP address assigned to the device. Thereafter, the processing by the outdoor unit 4 proceeds to step S206.

### Step S206

The outdoor unit 4 determines whether a certain time period has passed since the IP address assigned to itself is acquired, that is, after the address response notification is received from the centralized controller 3. When the certain time period has passed (YES in step S206), the outdoor unit 4 ends the IP address assignment processing. Conversely, when the certain time period has not passed (NO in step S206), the processing by the outdoor unit 4 returns to step S203.

As described above, in the air conditioning system 1 according to the present embodiment, each of the centralized controller 3 and the outdoor units 4 has the DHCP server function, and at the startup of the system, the centralized controller 3 assigns an IP address to each of the devices connected to the transmission line 9 that is the integrated transmission line, and each of the outdoor units 4 assigns an IP address to each of the devices connected thereto via the transmission line 10 that is the internal-external transmission line.

This configuration enables IP communication in the entire system while eliminating the need for a dedicated device for assigning an IP address.

Furthermore, since there is no need to set addresses to devices individually via an address setting receiver such as a DIP switch or a rotary switch, a great reduction in workload can be achieved. Furthermore, since the address setting receiver need not be included in the devices, a cost reduction can be achieved.

Furthermore, since various IP communication devices can be easily added to the system configuration, a significant improvement in system scalability can be achieved.

### Modified Example 1

Although the aforementioned embodiment describes an example in which the centralized controller 3 assigns IP addresses only to the devices connected to the transmission line 9 that is the integrated transmission line, in other words, only to the outdoor units 4a and 4b, the sensor device 6a, and the assistance device 7a, the centralized controller 3 may assign IP addresses to the devices connected only to the transmission line 10 that is the internal-external transmission line, in other words, to the indoor units 5a-5d, the sensor devices 6b and 6c, the assistance devices 7b and 7c, and the remote controllers 8a and 8b. In this case, the outdoor unit 4 need not include the DHCP server function. In the case of the configuration in which the outdoor unit 4 includes the DHCP server function, this function is taken to be disabled before shipment.

Similarly to the aforementioned embodiment, at the startup of the air conditioning system 1, each of the devices other than the outdoor unit 4 that are connected transmission line 10 broadcasts the address request notification via the transmission line 10. The outdoor unit 4, upon receiving the address request notification from any of the devices via the transmission line 10 to which the outdoor unit 4 is connected, transfers the address request notification onto the transmission line 9. The centralized controller 3 assigns an IP address to the device upon receiving the address request notification, and transmits to the device the address response notification storing the assigned IP address.

### Modified Example 2

The outdoor unit 4 may determine, in the case of not being connected to the transmission line 9 that is the integrated transmission line, at the startup of the air conditioning system 1, an IP address to be assigned to itself, by itself, based on the range of IP addresses predefined by the system administrator.

### Modified Example 3

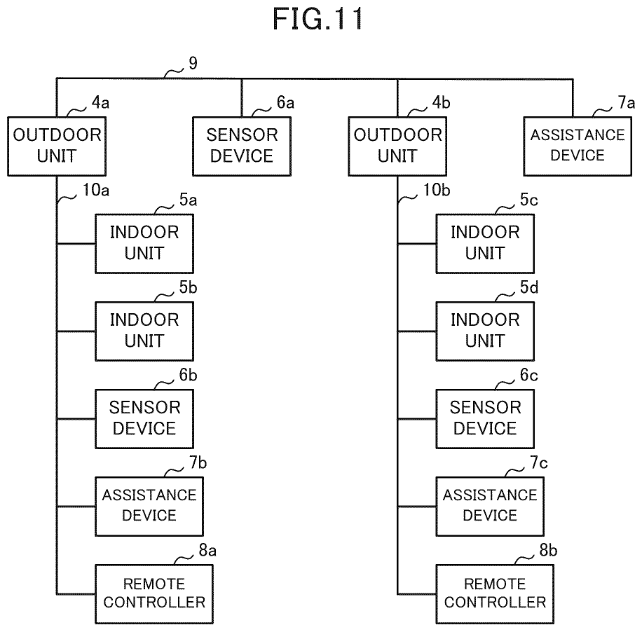

In the case of an air conditioning system as illustrated in FIG. 11 with system configuration that does not include the centralized controller 3, the configuration may be employed in which any one outdoor unit 4 of multiple outdoor units 4 is selected as a representative device and the representative device assigns IP addresses to all of the devices in the air conditioning system. In this case, the DHCP server function of each of the outdoor units 4 is taken to be disabled before shipment, and the DHCP server function of the outdoor unit 4 selected as the representative device is taken to be switched from disabled to enabled by the system administrator.

For example, switching of the DHCP server function between enabled and disabled may be performed with operation of a DIP switch, a rotary switch, or the like included in the outdoor unit 4. As another example, switching of the DHCP server function between enabled and disabled may be performed by connecting a terminal device such as a smartphone, a tablet terminal, or a laptop personal computer (PC) to the outdoor unit 4 to allow communication and operating the terminal device, or as still another example, switching of the DHCP server function between enabled and disabled may be performed by inserting a recording medium storing information indicating enabled or disabled, such as a USB memory or a memory card, into the outdoor unit 4 and causing the information to be read.

At the startup of the air conditioning system, the outdoor unit 4 as the representative device with the DHCP server function enabled determines an IP address to be assigned to itself, by itself, based on the range of IP addresses predefined by the system administrator. In the explanation below, the representative device is taken to be the outdoor unit 4a of FIG. 11. Similarly to the aforementioned embodiment, at the startup of the air conditioning system, each of the devices other than the outdoor unit 4a that are connected transmission line 9, in other words, the sensor device 6a, the outdoor unit 4b, and the assistance device 7a, broadcasts the address request notification via the transmission line 9.

Upon receiving such an address request notification, the outdoor unit 4a determines, based on the predefined range of IP addresses as described above, the IP address to be assigned to the device as a transmission source of the address request notification. The outdoor unit 4a sends, to the device that is the sensor device 6a, the outdoor unit 4b, or the assistance device 7a, the address response notification storing the assigned IP address.

Additionally, similarly to the aforementioned embodiment, at the startup of the air conditioning system, each of the devices connected only to the transmission line 10, in other words, the indoor units 5a-5d, the sensor devices 6b and 6c, the assistance devices 7b and 7c, and the remote controllers 8a and 8b, broadcasts the address request notification via the transmission line 10. Similarly to the aforementioned embodiment, upon receiving the address request notification from each of the devices connected thereto via the transmission line 10a, in other words, the indoor units 5a and 5b, the sensor device 6b, the assistance device 7b, and the remote controller 8a, the outdoor unit 4a automatically assigns an IP address to each of the devices and sends, to each of the devices, the address response notification storing the assigned IP address.

Additionally, upon receiving the address request notification from each of the devices connected to the outdoor unit 4b via the transmission line 10b, in other words, the indoor units 5c and 5d, the sensor device 6c, the assistance device 7c, and the remote controller 8b, the outdoor unit 4a automatically assigns an IP address to each of the devices and sends, to each of the devices, the address response notification storing the assigned IP address.

### Modified Example 4

A wired communication method using Wavelet Orthogonal Frequency Division Multiplexing (OFDM) that is hereinafter referred to as the “second communication method” may be used for communication between the devices via the transmission line 10 that is the internal-external transmission line. Additionally, the second communication method may also be used for communication between the devices via the transmission line 9 that is the integrated transmission line. Such configuration enables omission of a high-frequency communication performance of wiring, thereby enabling a reduction in a wiring cost and flexible wiring in exchange for omission of a high-frequency communication performance, and further enabling high-speed communication and enabling long-distance communication with a multi-hop function.

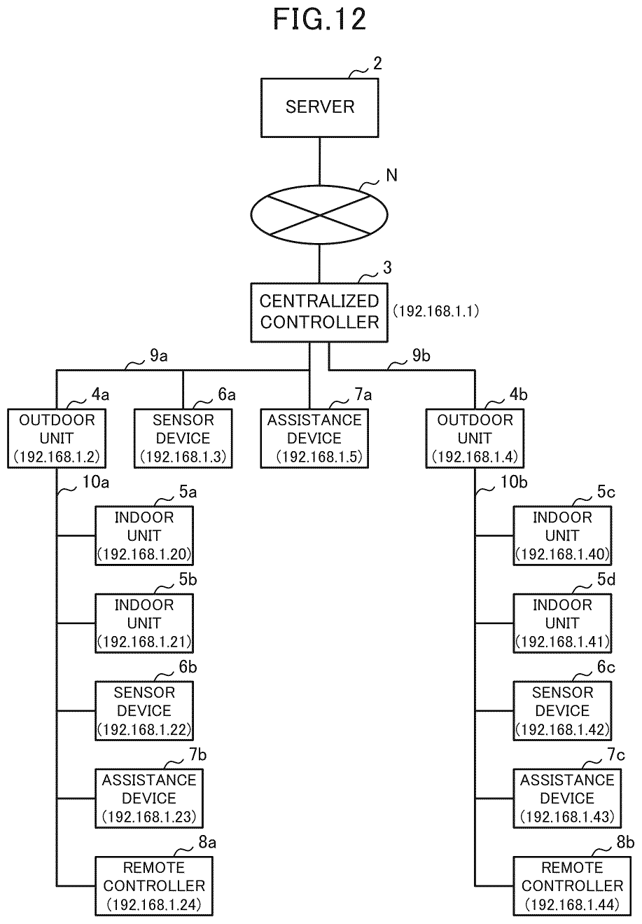

As another example, the configuration may be employed in which the second communication method is used for communication between the devices via the internal-external transmission line whereas both the first communication method (that is, Ethernet®) and the second communication method are used for the integrated transmission line. In this case, the centralized controller 3 includes communication interfaces that correspond to the first communication method and the second communication method, respectively. For example, in the air conditioning system illustrated in FIG. 12, the second communication method is used for the communication between the devices via the transmission lines 10a and 10b that are each the internal-external transmission line, the first communication method is used for the communication between the devices via the transmission line 9a that is the integrated transmission line, and the second communication method is used for the communication between the devices via the transmission line 9b that is the integrated transmission line.

The configuration as illustrated in FIG. 12 enables coexistence in an air conditioning system of (i) the outdoor unit 4 with a large scale due to the inclusion of the communication interfaces corresponding to the first communication method and the second communication method, respectively (in this example, the outdoor unit 4a), and (ii) the outdoor unit 4 with a small scale due to the inclusion of the communication interface corresponding to the second communication method only (in this example, the outdoor unit 4b), thereby enabling cooperative control, with the centralized controller 3, of both of the outdoor units 4 and the devices connected to the outdoor units 4.

### Modified Example 5

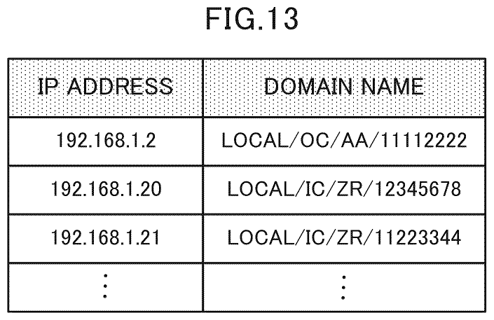

In the air conditioning system 1 according to Embodiment 1, the centralized controller 3 may have a Domain Name System (DNS) server function. In detail, the centralized controller 3 collects, from each of the air conditioners, that is, each of the outdoor units 4 and each of the indoor units 5, attribute information of the air conditioner, such as information of a type (outdoor unit or indoor unit), a model name, and a manufacturer's serial number, and generates for each of the air conditioners a domain name corresponding to the IP address of the air conditioner based on the collected attribute information and a predefined domain generation rule. The centralized controller 3 associates, for each of the air conditioners, the IP address and the domain name and manages in a domain name management table stored in the auxiliary storage device 35. FIG. 13 illustrates an example of the domain name management table.

In the air conditioning system as illustrated in FIG. 11 according to Modified Example 3 described above, each of the outdoor units 4 may include the DNS server function. In this case, the outdoor unit 4 selected as the representative device, that is, the outdoor unit 4 to assign an IP address to each device, collects the attribute information from each of the air conditioners and generates for each of the air conditioners a domain name corresponding to the IP address of the air conditioner based on the collected attribute information and a predefined domain generation rule. The representative device associates, for each of the air conditioners, the IP address and the domain name and manages in the domain name management table as illustrated in FIG. 13 that is stored in the auxiliary storage device 44. In this modified example, the DHCP server function and the DNS server function of each of the outdoor units 4 are taken to be disabled before shipment, and the DHCP server function and the DNS server function of the outdoor unit 4 selected as the representative device are taken to be switched from disabled to enabled by the system administrator with the method described in Modified Example 3.

### Modified Example 6

The functional elements of the centralized controller 3 as illustrated in FIG. 5 may be achieved wholly or partially by dedicated hardware. Furthermore, the functional elements of the outdoor unit 4 as illustrated in FIG. 7 may be achieved wholly or partially by dedicated hardware. The dedicated hardware is, for example, a single circuit, a composite circuit, a programmed processor, an application specific integrated circuit (ASIC), a field-programmable gate array (FPGA), or a combination thereof.

The technical concepts for the above modified examples may be achieved independently or in combination as appropriate.

### Embodiment 2

Next, Embodiment 2 of the present disclosure is described. In the description below, structural elements or the like that are common with Embodiment 1 are assigned the same reference sign, and explanation for such elements is omitted.

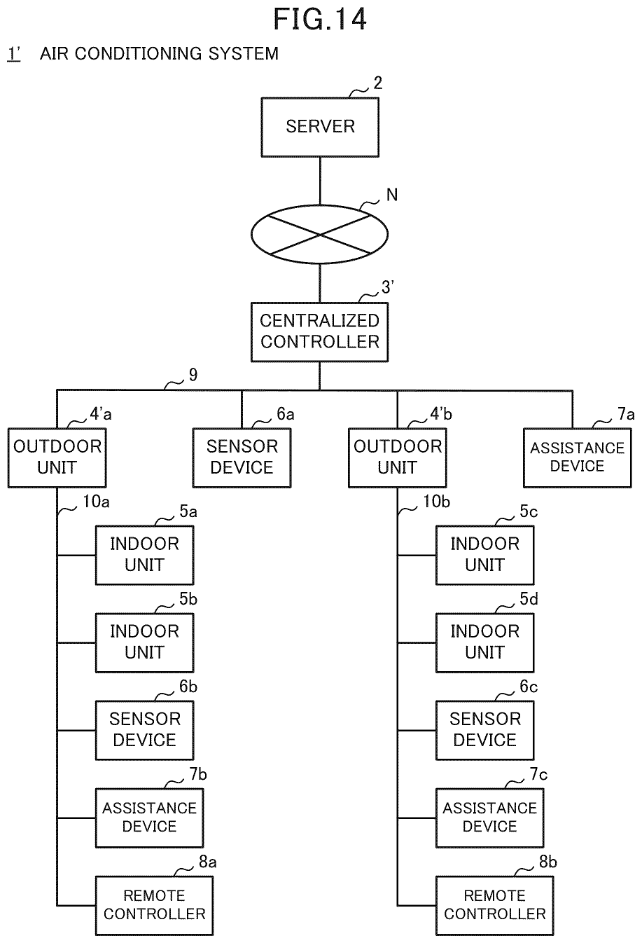

FIG. 14 illustrates overall configuration of an air conditioning system 1′ according to Embodiment 2 of the present disclosure. The air conditioning system 1′ is an example of an air conditioning system according to the present disclosure. The air conditioning system 1′ is, for example, a system that performs air conditioning of a building such as an office building or a shop, and includes a server 2, a centralized controller 3′, outdoor units 4′a and 4′b, indoor units 5a-5d, sensor devices 6a-6c, assistance devices 7a-7c, and remote controllers 8a and 8b.

The air conditioning system 1′ according to the present embodiment is different from the air conditioning system 1 according to Embodiment 1 in that a global IP address based on Internet Protocol version 6 (IPv6) is preset before shipment for each of the devices, that is, the centralized controller 3′, the outdoor units 4′a and 4′b, the indoor units 5a-5d, the sensor devices 6a-6c, the assistance devices 7a-7c, and the remote controllers 8a and 8b. Due to this configuration, at the startup of the air conditioning system 1′, the outdoor units 4′a and 4′b, the indoor units 5a-5d, the sensor devices 6a-6c, the assistance devices 7a-7c, and the remote controllers 8a and 8b do not send the address request notification for requesting an IP address.

### Centralized Controller 3′

The centralized controller 3′ is a device for performing centralized control of the devices in the air conditioning system 1′ that are the outdoor units 4′a and 4′b, the indoor units 5a-5d, the sensor devices 6a-6c, and the assistance devices 7a-7c, such as cooperation control of these devices, and is installed at a place allowing entry only by the person involved, such as a control room in the building. The hardware configuration of the centralized controller 3′ is similar to that of the centralized controller 3 according to Embodiment 1 as illustrated in FIG. 2. Functions of the centralized controller 3′ are described below in detail.

### Outdoor Units 4′a and 4′b

The outdoor unit 4′a is connected to the transmission line 9 and a transmission line 10a that is an internal-external transmission line. The outdoor unit 4′a and the indoor units 5a and 5b are connected via the transmission line 10a and are also connected via non-illustrated first refrigerant piping for circulation of refrigerant. That is, the outdoor unit 4′a and the indoor units 5a and 5b constitute a single refrigerant system.

The outdoor unit 4′b is connected to the transmission line 9 and a transmission line 10b that is an internal-external transmission line. The outdoor unit 4′b and the indoor units 5c and 5d are connected via the transmission line 10b and are also connected via non-illustrated second refrigerant piping for circulation of refrigerant that is different from the aforementioned first refrigerant piping. That is, the outdoor unit 4′b and the indoor units 5c and 5d constitute a single refrigerant system.

Hereinafter, in explanation of matters that are common between the outdoor units 4′a and 4′b, these outdoor units are referred to as the outdoor units 4′ without individual designation. The hardware configuration of the outdoor unit 4′ is similar to that of the outdoor unit 4 according to Embodiment 1 as illustrated in FIG. 3. Functions of the outdoor unit 4′ are described below in detail.

### Functional Configuration of Centralized Controller 3′

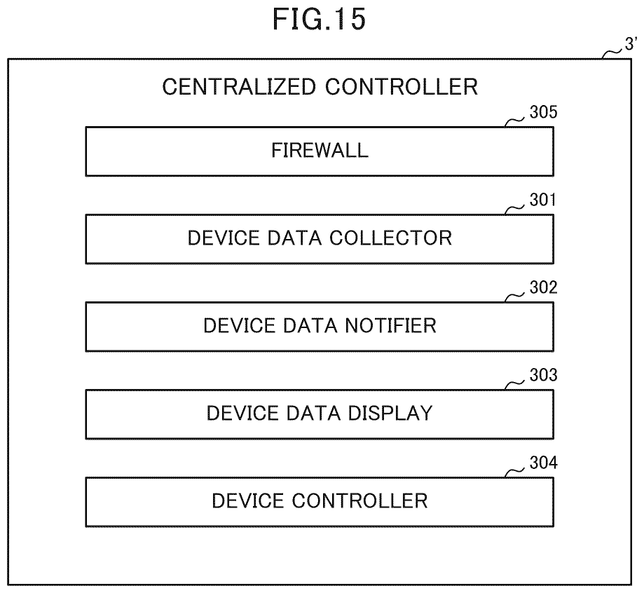

FIG. 15 illustrates functional configuration of the centralized controller 3′. As illustrated in FIG. 15, the centralized controller 3′ includes a firewall 305, a device data collector 301, a device data notifier 302, a device data display 303, and a device controller 304. These functional elements are achieved by execution, by the CPU of the control circuit 34 included in the centralized controller 3′, of the integrated control program stored in the auxiliary storage device 35. The functional configuration of the centralized controller 3′ is different from the functional configuration of the centralized controller 3 as illustrated in FIG. 5 in that the firewall 305 is included in place of the IP address assigner 300. The firewall 305 restricts external access based on a predetermined rule.

### Functional Configuration of Outdoor Unit 4′

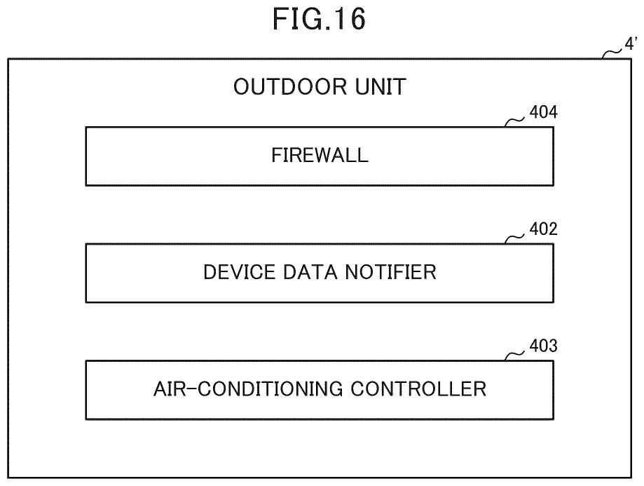

FIG. 16 illustrates functional configuration of the outdoor unit 4′. As illustrated in FIG. 16 the outdoor unit 4′ includes a firewall 404, a device data notifier 402, and an air-conditioning controller 403. These functional elements are achieved by execution, by the CPU of the control circuit 43 included in the outdoor unit 4′, of the outdoor unit program stored in the auxiliary storage device 44. The functional configuration of the outdoor unit 4′ is different from the functional configuration of the outdoor unit 4 as illustrated in FIG. 7 in that the firewall 404 is included in place of the IP address acquirer 400 and the IP address assigner 401. The firewall 404 restricts external access based on a predetermined rule.

As described above, in the air conditioning system 1′ according to the present embodiment, the global IP address based on IPv6 is preset before shipment for each of the devices. This configuration enables IP communication in the entire system while eliminating the need for a dedicated device for assigning an IP address.

Furthermore, since there is no need to set addresses to devices individually via an address setting receiver such as a DIP switch or a rotary switch, a great reduction in workload can be achieved. Furthermore, since the address setting receiver need not be included in the devices, a cost reduction can be achieved.

Furthermore, since various IP communication devices can be easily added to the system configuration, a significant improvement in system scalability can be achieved.

Furthermore, since each of the centralized controller 3′ and the outdoor units 4′ has a firewall function, unauthorized external operation of the air conditioners can be prevented.

### Modified Example 1

A wired communication method using Wavelet OFDM that is hereinafter referred to as the “second communication method” may be used for communication between devices via the transmission line 10 that is the internal-external transmission line may be employed. Additionally, the second communication method may also be used for communication between the devices via the transmission line 9 that is the integrated transmission line. Such configuration enables omission of a high-frequency communication performance of wiring, thereby enabling a reduction in a wiring cost and flexible wiring in exchange for omission of a high-frequency communication performance, and further enabling high-speed communication and enabling long-distance communication with a multi-hop function.

As another example, the configuration may be employed in which the second communication method is used for communication between the devices via the internal-external transmission line whereas both the first communication method (that is, Ethernet®) and the second communication method are used for the integrated transmission line. In this case, the centralized controller 3′ includes communication interfaces that correspond to the first communication method and the second communication method, respectively. This configuration enables coexistence in an air conditioning system of (i) the outdoor unit 4′ with a large scale due to the inclusion of the communication interfaces corresponding to the first communication method and the second communication method, respectively, and (ii) the outdoor unit 4′ with a small scale due to the inclusion of the communication interface corresponding to the second communication method only, thereby enabling cooperative control, with the centralized controller 3′, of both of the outdoor units 4′ and the devices connected to the outdoor units 4′.

### Modified Example 2

The centralized controller 3′ may have a DNS server function. In detail, the centralized controller 3′ collects, from each of the air conditioners, that is, each of the outdoor units 4′ and each of the indoor units 5, attribute information of the air conditioner, such as information of a type (outdoor unit or indoor unit), a model name, and a manufacturer's serial number, and generates for each of the air conditioners a domain name corresponding to the IP address of the air conditioner based on the collected attribute information and a predefined domain generation rule. The centralized controller 3′ associates, for each of the air conditioners, the IP address and the domain name and manages in a domain name management table stored in the auxiliary storage device 35, as illustrated in FIG. 13.

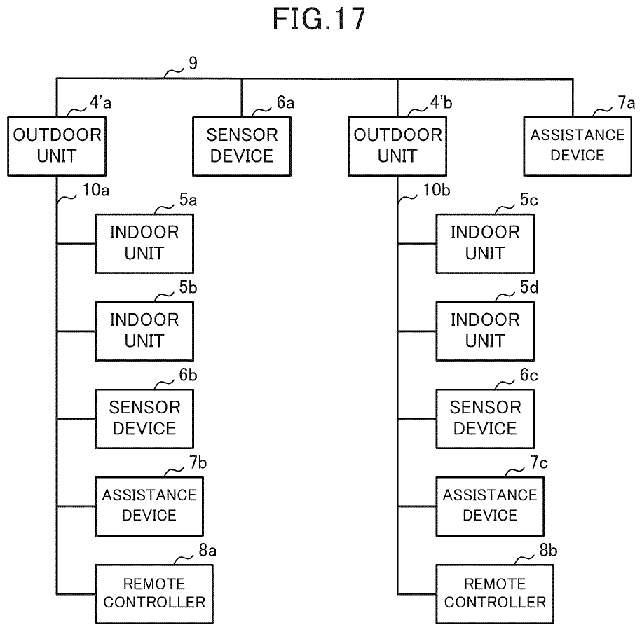

In the case of an air conditioning system as illustrated in FIG. 17 with system configuration that does not include the centralized controller 3′, the configuration may be employed in which any one outdoor unit 4′ of multiple outdoor units 4′ is selected as a representative device and the representative device generates a domain name of each of the air conditioners. That is, the representative device collects the attribute information from each of the air conditioners and generates for each of the air conditioners a domain name corresponding to the IP address of the air conditioner based on the collected attribute information and a predefined domain generation rule. The representative device associates, for each of the air conditioners, the IP address and the domain name and manages in the domain name management table as illustrated in FIG. 13 that is stored in the auxiliary storage device 44. In this case, although all of the outdoor units 4′ have the DNS server function, the DNS server function is taken to be disabled before shipment, and the DNS server function of the outdoor unit 4′ selected as the representative device is taken to be switched from disabled to enabled by the system administrator.

For example, switching of the DNS server function between enabled and disabled may be performed with operation of a DIP switch, a rotary switch, or the like included in the outdoor unit 4′. As another example, switching of the DNS server function between enabled and disabled may be performed by connecting a terminal device such as a smartphone, a tablet terminal, or a laptop PC to the outdoor unit 4′ to allow communication and operating the terminal device, or as still another example, switching of the DNS server function between enabled and disabled may be performed by inserting a recording medium storing information indicating enabled or disabled, such as a USB memory or a memory card, into the outdoor unit 4′ and causing the information to be read.

### Modified Example 3

The functional elements of the centralized controller 3′ as illustrated in FIG. 15 may be achieved wholly or partially by dedicated hardware. Furthermore, the functional elements of the outdoor unit 4′ as illustrated in FIG. 16 may be achieved wholly or partially by dedicated hardware. The dedicated hardware is, for example, a single circuit, a composite circuit, a programmed processor, an ASIC, an FPGA, or a combination thereof.

The technical concepts for the above modified examples may be achieved independently or in combination as appropriate.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be suitably used for an air conditioning system that includes multiple air conditioners.

1. An air conditioning system, comprising:
a plurality of devices that at least include a centralized controller, one or more outdoor units, and one or more indoor units wherein
at startup of the system, the centralized controller assigns an IP address to, among the plurality of devices, each of all devices connected to an integrated transmission line, and
each of the one or more outdoor units assigns the IP address to each of all devices connected to the outdoor unit via an internal-external transmission line.

2. (canceled)

3. (canceled)

4. The air conditioning system according to claim 1, wherein
the centralized controller acquires attribute information from each of the one or more outdoor units and each of the one or more indoor units, generates for each of the one or more outdoor units a domain name corresponding to the IP address of the outdoor unit based on the acquired attribute information of the outdoor unit, and generates for each of the one or more indoor units a domain name corresponding to the IP address of the indoor unit based on the acquired attribute information of the indoor unit.

5. An air conditioning system, comprising:
a plurality of devices that at least include one or more outdoor units and one or more indoor units, wherein
at startup of the system, a representative device that is a device among the one or more outdoor units assigns an IP address to each of the plurality of devices.

6. The air conditioning system according to claim 5, wherein
the representative device acquires attribute information from each of the one or more outdoor units and each of the one or more indoor units, generates for each of the one or more outdoor units a domain name corresponding to the IP address of the outdoor unit based on the acquired attribute information of the outdoor unit, and generates for each of the one or more indoor units a domain name corresponding to the IP address of the indoor unit based on the acquired attribute information of the indoor unit.

7. An air conditioning system, comprising:
a plurality of devices that at least include one or more outdoor units and one or more indoor units, wherein
a global IP address is set to each of the plurality of devices, and
a representative device that is a device among the one or more outdoor units acquires attribute information from each of the one or more outdoor units and each of the one or more indoor units, generates for each of the one or more outdoor units a domain name corresponding to the IP address of the outdoor unit based on the acquired attribute information of the outdoor unit, and generates for each of the one or more indoor units a domain name corresponding to the IP address of the indoor unit based on the acquired attribute information of the indoor unit.

8. The air conditioning system according to claim 1, wherein
communication between at least some of the plurality of devices is performed in a wired communication method using Wavelet OFDM.

9. An outdoor unit, comprising:
circuitry to
acquire an IP address from a centralized controller, and
assign an IP address to each of all devices connected to the outdoor unit via an internal-external transmission line.

10. The air conditioning system according to claim 4, wherein
communication between at least some of the plurality of devices is performed in a wired communication method using Wavelet OFDM.

11. The air conditioning system according to claim 5, wherein
communication between at least some of the plurality of devices is performed in a wired communication method using Wavelet OFDM.

12. The air conditioning system according to claim 6, wherein
communication between at least some of the plurality of devices is performed in a wired communication method using Wavelet OFDM.

13. The air conditioning system according to claim 7, wherein
communication between at least some of the plurality of devices is performed in a wired communication method using Wavelet OFDM.
